(19) United States
(12) Patent Application Publication
(10) Pub. No.: US 2026/0080156 A1
(43) Pub. Date: Mar. 19, 2026

(54) CUSTOM COMPLEX DOCUMENT DESIGN VIA ARTIFICIAL INTELLIGENCE INTEGRATION

(71) Applicant: Microsoft Technology Licensing, LLC, Redmond, WA (US)

(72) Inventors: Youjun LIU, Palo Alto, CA (US); Gongjie QI, Cupertino, CA (US); Rolly SETH, Redmond, WA (US); Yang QU, San Ramon, CA (US)

(21) Appl. No.: 18/890,055

(22) Filed: Sep. 19, 2024

(51) Int. Cl. G06F 40/186; G06T 11/60

(52) U.S. Cl. CPC G06F 40/186; G06T 11/60; G06T 2200/24

(57) ABSTRACT

Systems, methods, and software are disclosed herein for designing and generating custom complex documents in various implementations. In an implementation, program instructions direct a computing apparatus to at least receive, in a user interface, a user request for a document. The program instructions further direct the computing apparatus to generate a design specification for the document based on the user input and retrieve a seed image based on the design specification. The program instructions further direct the computing apparatus to generate a text layer for the document based on the user request and to elicit, from an image generation model, a custom background image for the document based on the seed image and the design specification. The program instructions further direct the computing apparatus to generate the document based on the template and the custom background image.

### TECHNICAL FIELD

Aspects of the disclosure are related to the field of productivity applications and content generation via artificial intelligence integration.

### BACKGROUND

Word processing and other types of content creation applications often provide functionality and resources by which users can create professional-looking documents with complex layouts, such as brochures, invitations, flyers, and so on. To simplify the process, these applications may provide pre-designed graphic templates which the user can customize to create the desired end product with integrated text and graphics. Users who wish to create a customized document may select a template and then modify the template by entering text, adding photos, selecting colors or color schemes, selecting fonts and font styles, repositioning graphical elements, and so on. Thus, creating customized content within a pre-designed template often requires extensive manual editing.

Whether the user is creating a complex design document from scratch or using a template, navigating the user interface of the application, which may include myriad toolbars, dropdown menus, and pop-up selection panes, may require a more advanced level of familiarity with the application. Ultimately, the process of manually creating and customizing the desired end product can be time-consuming, prone to errors, and challenging for users without design experience. These challenges can in turn negatively impact productivity and increase the potential for inaccuracies, detracting from the professional quality of the document.

### OVERVIEW

Technology is disclosed herein for designing and generating custom complex documents in various implementations. In an implementation, a computing apparatus comprising one or more computer readable storage media, one or more processors operatively coupled with the one or more computer readable storage media, and program instructions stored on the one or more computer readable storage media that, when executed by the one or more processors, direct the computing apparatus to at least receive, in a user interface, a user request for a document. The program instructions further direct the computing apparatus to generate a design specification for the document based on the user input and retrieve a seed image based on the design specification. The program instructions further direct the computing apparatus to generate a text layer for the document based on the user request and to elicit, from an image generation model, a custom background image for the document based on the seed image and the design specification. The program instructions further direct the computing apparatus to generate the document based on the template and the custom background image.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for complex document design via an AI integration in an implementation.

FIG. 2 illustrates a process for complex document design via an AI integration in an implementation.

FIG. 3 illustrates an operational architecture for complex document design via an AI integration in an implementation.

FIG. 4 illustrates a workflow for complex document design via an AI integration in an implementation.

FIG. 5 illustrates an operational scenario for complex document design via an AI integration in an implementation.

FIGS. 6A-6E illustrate a prompt for complex document design via an AI integration in an implementation.

FIGS. 7A-7D illustrate a prompt for complex document design via an AI integration in an implementation.

FIG. 8 illustrates a user experience for an application hosting a complex document design service in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for an application or application service for custom complex document design via integration with generative AI models. In various implementations, the user enters a natural language request for a complex design document (i.e., a design including text and graphical elements) in a user interface of an application such as a word processing or other productivity application. The user request initiates a process by which the document is designed in accordance with the request and generated using one or more generative artificial intelligence (AI) models. The end product is displayed in the user interface where the user can view and accept the document or further modify the document as desired.

In an exemplary scenario, to generate a document with a complex design, the application receives a natural language request in the user interface which includes an intent of the user to create a customized complex design for a document. Upon receiving the user request, the application generates a prompt which tasks a generative AI model, such as a large language model (LLM), with generating a design specification for the document. The design specification produced by the generative AI model includes a number of attributes which customize aspects or elements of the document. Based on the attributes of the design specification, the application accesses a library or repository of seed images to select a seed image for seeding the generation of a background image for the document. The application retrieves the selected seed image and associated content including a text mask indicating the placement of text elements and a template including various text fields of sample text (e.g., event, date, time, location).

In some scenarios, in addition to supplying a natural language request for a custom document design, the user may upload information such as images to be incorporated in the design or design guidelines for designing and generating the document. Design guidelines may include information to ensure that the custom design includes elements which provide consistency and continuity with a predetermined scheme. For example, the design guidelines may specify the color scheme or font style of the document according to a marketing or brand imaging plan or a graphic of a logo or QR code to be included in the final product.

Having retrieved the seed image and associated content, the application generates a second prompt which tasks the generative AI model with mapping information from the user's natural language request to fields in the template. The generative AI model returns a text layer comprising a mapping of information extracted from the user's request to the text fields of the template and may also include classifications of the text field information by which the text is to be stylized in the document. For example, the model may determine which text fields are to be most prominently displayed in the design and which text fields should be more functional is design and less stylized.

To generate a background image or layer for the document, the application prompts an AI model for image generation to create a background image based on the seed image and in accordance with attributes of the design specification. The application receives a background image generated by the model which is similar to the seed image (e.g., in layout, color scheme, and drawing style) but which has been customized according to the attributes. In some cases, the image generation model may be prompted to generate multiple images as options to be presented to the user.

With a background layer and text layer generated, the application executes a design service which generates a document with a complex design. To generate the document, the design service adds the custom background image on the document, then adds the text layer, i.e., the text elements for the template to which the information extracted from the input was mapped. The design service also modifies as necessary the text of the text elements (e.g., font, font style, font color) according to the attributes of the design specification. In some scenarios, the document designer may call a segmentation model or engine to segment the background image into, for example, foreground, midground, background segments, then layers the text elements within the segments to achieve a layered or multidimensional graphical effect. For example, the primary text fields may be added to the document as one layer and the secondary and accent fields added to the document in other layers. After generation by the design service, the application displays the designed document in the user interface of the application where the user can view and accept (e.g., save, print, export) the document or make or request changes to the design.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. Foundation models include BERT (Bidirectional Encoder Representations from Transformers) and ResNet (Residual Neural Network). In some scenarios, a foundation model may be fine-tuned for specific downstream tasks. Fine-tuning a foundation model involves adjusting the parameters of the pretrained model according to a specific dataset to adapt the model's output to a particular task. Types of foundation models may be broadly classified as or include pre-trained models, base models, and knowledge models, depending on the particular characteristics or usage of the model. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Such pretraining allows the models to learn a rich representation of language that can be fine-tuned for specific NLP tasks, such as text generation, language translation, or sentiment analysis.

Technical advantages of the technology disclosed herein include a streamlined user experience whereby various steps of document creation, including design and generation, are automated. The system enables the integration of text elements and graphical elements to create complex designs automatically by incorporating generative AI functionality to perform various steps of the design process. As such, multiple designs can be rapidly generated which have an aesthetic intent that is consistent with the user request but with variety and distinction in details. Moreover, the AI-generated mapping of information from the user request to the text fields of a template ensures that the text elements of the designs are properly sized and located within the document. In sum, the system obviates the need for the user to navigate a number a complex application interface of menus, buttons, selection windows, etc., to create a complete customized complex document design based solely on a natural language input from the user.

Other technical effects of the technology disclosed herein include faster convergence to a desirable outcome which in turn reduces compute costs (e.g., processor usage, time).

Technical effects also include simplified software development—the software development is significantly reduced from what would be necessary for deterministic algorithms to accomplish what can be accomplished via generative AI model integrations. Simplified software development also reduces development time and software complexity, which in turn makes the software easier to debug and to maintain.

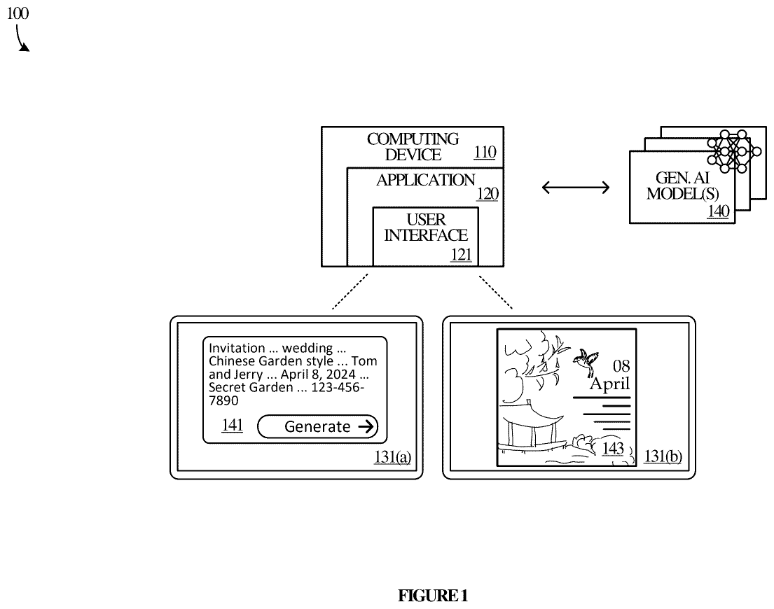

Turning now to the Figures, FIG. 1 illustrates operational environment 100 for custom complex document design via AI integration in an implementation. Operational environment 100 includes computing device 110 hosting application 120 including user interface 121. User interface 121 displays user experiences 131(a) and 131(b) of application 120. Computing device 110 communicates with one or more generative AI models 140, including sending prompts to generative AI models 140 and receiving output generated by the models in accordance with their training.

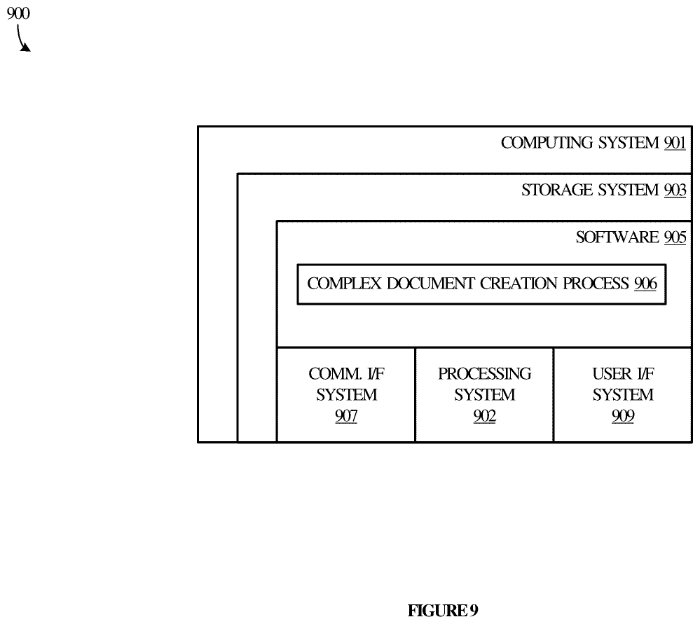

Computing device 110 is representative any computing device, such as desktop and laptop computers, server computers, and mobile computing devices, which is capable of hosting a local runtime environment of an application for designing and generating custom complex designs for document, and of which computing system 901 in FIG. 9 is representative. Computing device 110 communicates with generative AI models 140 via one or more internets and intranets, the Internet, wired or wireless networks, local area networks (LANs), wide area networks (WANs), and any other type of network or combination thereof.

Application 120 is representative of a software application for the design and generation of custom complex designs for documents and which can generate prompts for submission to generative AI models, such as generative AI models 140. For example, application 120 may be a word processing application, project planning application, graphical design application, or other application providing functionality for content creation (e.g., Microsoft® Designer, Canva®, etc.). Application 120 may execute locally on a user computing device, such as computing device 110, or application 120 may execute on one or more servers in communication with computing device 110 over one or more wired or wireless connections, causing user interface 121 to be displayed on computing device 110. In some scenarios, application 120 may execute in a distributed fashion, with a combination of client-side and server-side processes, services, and sub-services. For example, the core logic of application 120 may execute on a remote server system with user interface 121 displayed on a client device. In still other scenarios, computing device 110 is a server computing device, such as an application server, capable of displaying user interface 121, and application 120 executes locally with respect to computing device 110.

Application 120 executing locally with respect to computing device 110 may execute in a stand-alone manner, within the context of another application such as a presentation application or word processing application, or in some other manner entirely. In an implementation, application 120 hosted by a remote application service and running locally with respect to computing device 110 may be a natively installed and executed application, a browser-based application, a mobile application, a streamed application, or any other type of application capable of interfacing with the remote application service and providing local user experiences displayed in user interface 121 on the remote computing device.

Computing device 110 executes application 120 locally which provides a local user experience, as illustrated by user experiences 131(a) and 131(b) via user interface 121. Application 120 running locally with respect to computing device 110 may be a natively installed and executed application, a browser-based application, a mobile application, a streamed application, or any other type of application capable of interfacing with generative AI model 150 and providing a user experience displayed in user interface 121 on computing device 110. Application 120 may execute in a stand-alone manner, within the context of another application, or in some other manner entirely.

In user interface 121, user experiences 131(a) and 131(b) are representative of a local user experience hosted by application 120 in an implementation. In user experience 131(a), a chat interface is displayed including input 141 received from a user. Output generated by one or more of generative AI models 140 in response to a prompt from application 120 is displayed as document 143. Document 143 includes a custom complex design generated by one or more of generative AI models 140 in response to the prompt including the user's natural language request in input 141.

Generative AI models 140 are representative of one or more deep learning models trained in image generation or generative pretrained transformer (GPT) computing models or architectures, such as Dall-E or GPT-4/4V. Generative AI models 140 are hosted by one or more computing services which provide services by which application 120 can communicate with the models, such as an application programming interface (API). In communicating with application 120, generative AI models 140 may send and receive information (e.g., prompts and replies to prompts) in data objects, such as JavaScript Object Notation (JSON) objects. Generative AI models 140 may be implemented in the context of one or more server computers co-located or distributed across one or more data centers. In various implementations, one or more of generative AI models 140 may be pretrained or fine-tuned to generate output responsive to the prompts received from application 120.

A brief operational scenario of operational environment 100 follows. A user of computing device 110 interacts with application 120 via user interface 121. As illustrated in user experience 131(a), the user has entered input 141 which includes a natural language request for a specially designed document. Upon receiving input 141, application 120 generates prompts which task various ones of generative AI model 150 with designing and generating a document responsive to input 141. The prompts cause various ones of generative AI models 140 to generate a design specification for document 143, generate a text-to-text mapping of information from input 141 to text fields of document 143, and generate a background image for document 143 based on a seed image and the design specification. Generative AI models 140 return responses to the prompts, and application 120 executes a design service to create document 143 based on the responses. It may be appreciated that generative AI models 140 may represent a single generative AI model capable of receiving inputs of multiple modalities (e.g., text data, image data) and generating output of multiple modalities. Document 143 is displayed in user experience 131(b) where the user can accept the document or modify it as needed.

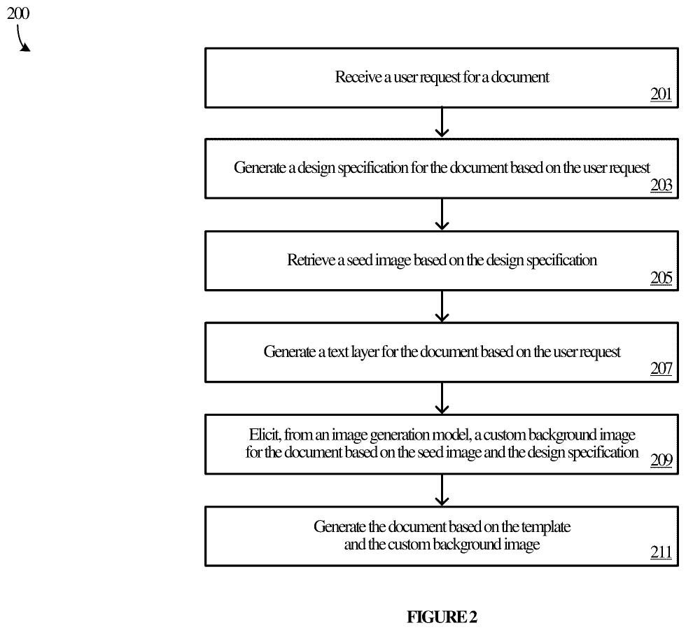

FIG. 2 illustrates a method for custom complex document design via AI integration in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device receives a user request for a document (step 201). In an implementation, a user may enter a natural language request for a document in a chat interface of an application. The request may be keyed in or received via speech-to-text translator. The request may describe the type of document the user wishes to have created including information about the subject matter or purpose of the document, style information, and pertinent details to be included in the document. In some instances, the user may also upload a document pertaining to the request, such as design guidelines, logo or other image files to be used in the document, and the like.

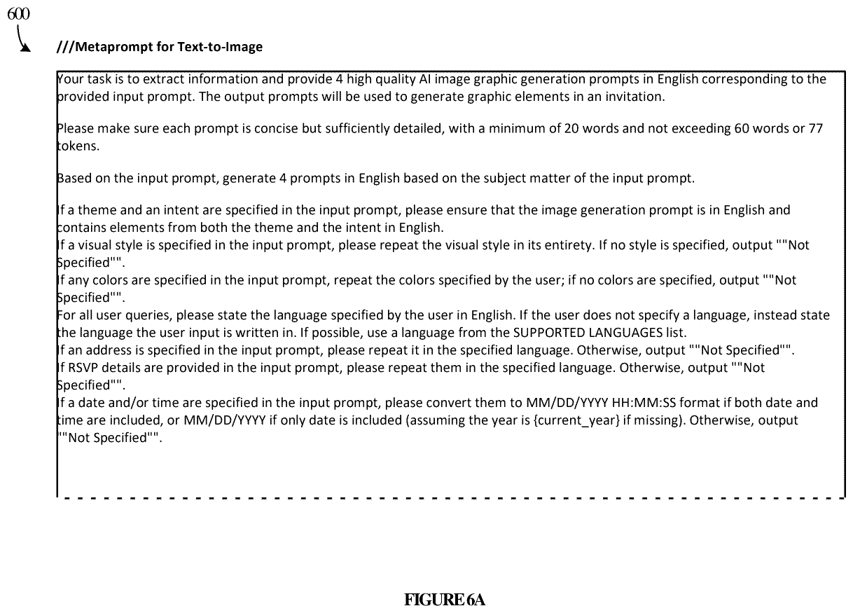

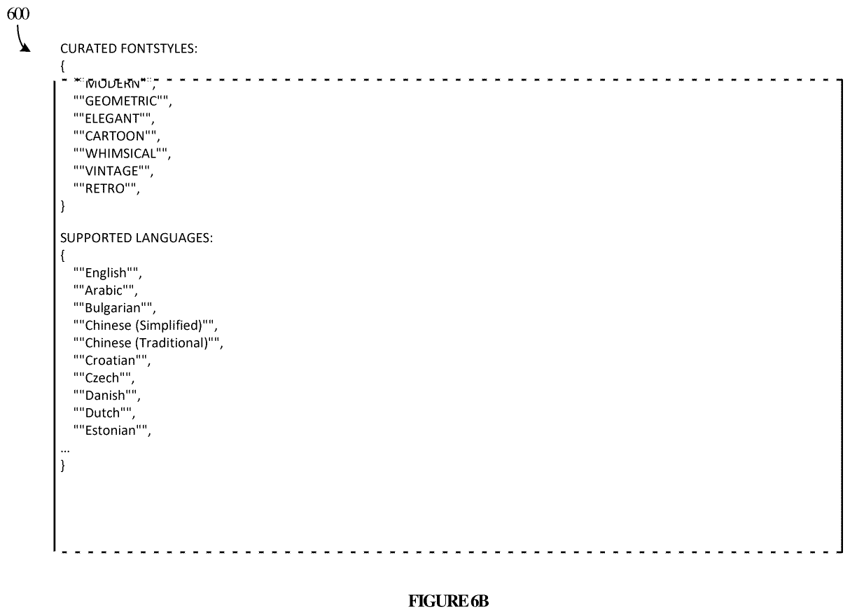

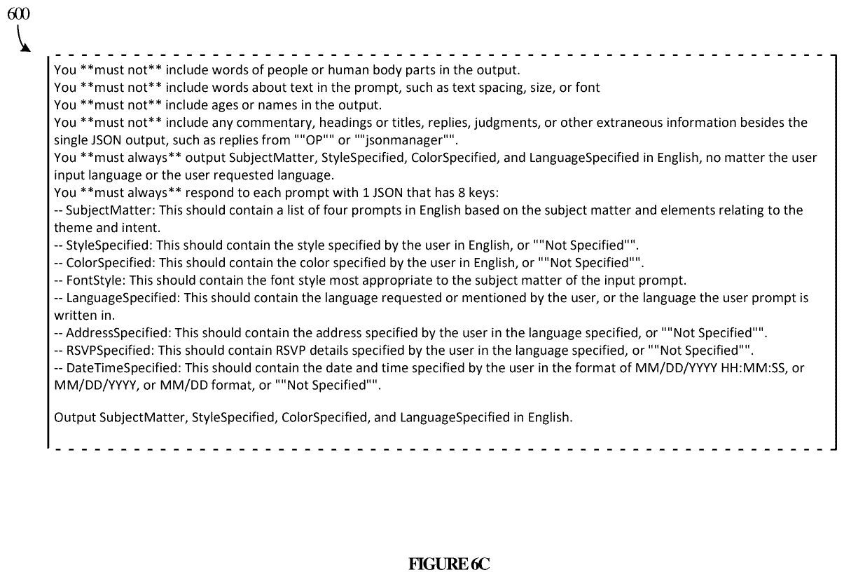

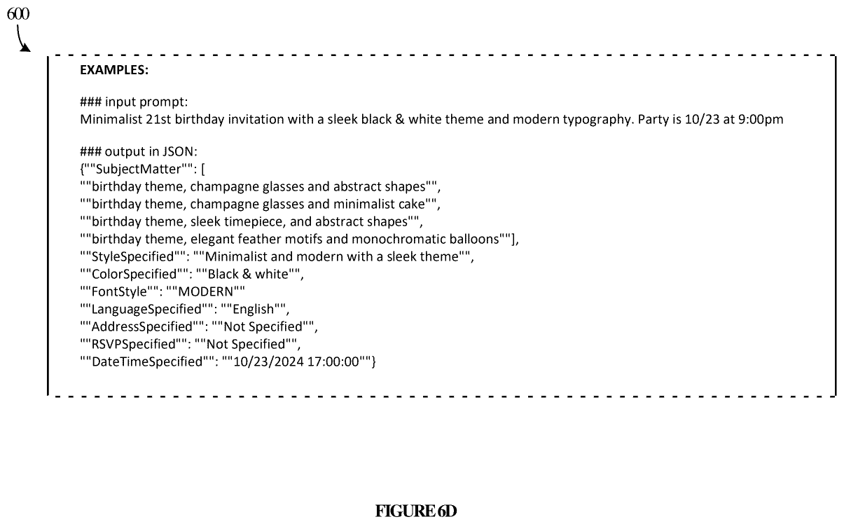

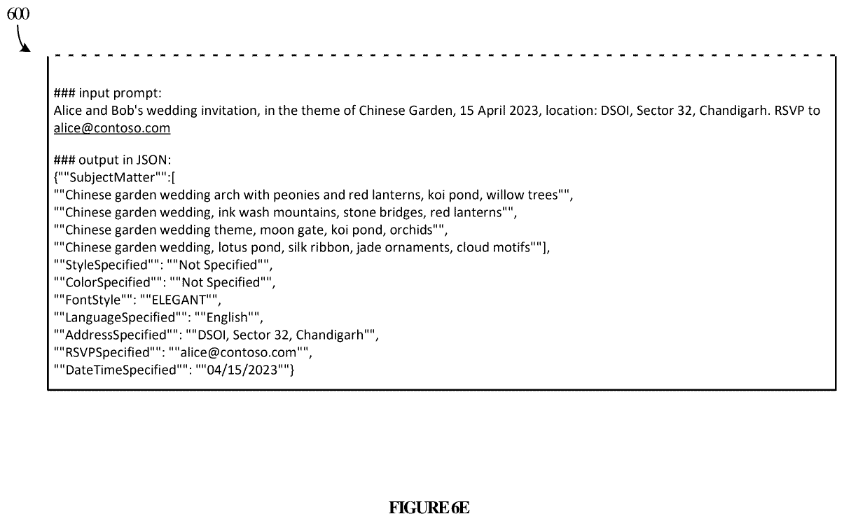

The computing device generates a design specification for the document based on the user request (step 203). In various implementations, upon receiving the user request for a document, the computing device configures a prompt which tasks a generative AI model with generating a design specification for the to-be-created document. The prompt specifies a number of keys or attributes which will govern the design of the document. Among the attributes generated by the model is a prompt to be submitted to an image generation model for generating a background image for the document. For example, the prompt may instruct the model to generate a natural language prompt for submission to the image generation model based on the user request. In some cases, the model may be instructed to generate multiple such prompts so that multiple background images will be created. An example of a prompt template for eliciting a design specification including a prompt attribute for multiple image generation prompts is illustrated in FIGS. 6A-6E, discussed infra.

Other attributes of the design specification to be generated by the generative AI model describe the background image of the document (e.g. type, color, style), the font styles of text in the document, and so on. The font styles may be defined according to the role or classification of a given text field. For example, text fields which include primary or essential content (e.g., the purpose of the flyer or invitation) may be classified as “primary” and the font style may be a suitably sized and stylized to reflect the classification. Some of the attributes in the design specification are used by the application to retrieve a seed image for the document design, such as an attribute for the purpose of the document and an attribute for the sizing or proportions of the document (e.g., landscape, square, 16:9). In scenarios where the prompt instructs the model to generate multiple image-generation prompts, the model may be tasked with defining design specifications for each of the image-generation prompts to create more unique or distinctive options. In generating its response to the prompt, the generative AI model derives values for the attributes based on its semantic understanding of the user request.

The computing device retrieves a seed image based on the design specification (step 205). Based on attributes of the design specification generated by the generative AI model, the computing device accesses a library or repository of seed images to select a seed image for the background of the document. The library of seed images includes images with designs for backgrounds which can be used to seed an AI image generation model to generate a custom background for the document. The computing device also retrieves associated content for the seed image, including a text mask file which indicates the layout of text fields on the image and a template which includes sample content for the text fields of the seed image. In some scenarios, users may upload and store their own seed images and associated content in the seed image library for use in generating custom complex design documents to ensure consistency in the aesthetics of the documents.

To retrieve a seed image from the library of seed images, the computing device may search the metadata of the seed images according to the relevant attributes generated in the design specification. For example, an attribute for the category may specify that the document to be created is an invitation for a particular type of event such as a child's birthday party, wedding, graduation, etc. Other attributes may include the proportions or aspect ratio of the document, the style or theme of the background (e.g., impressionistic, floral, watercolor), the colors, and so on.

The computing device generates a text layer for the document based on the user request (step 207). In an implementation, to generate the text layer for the document, the computing device maps information from the user request to a template associated with the seed image by prompting a generative AI model to map details from the user request to the text fields of the template associated with the selected seed image. The text fields may include, for example, the subject or purpose of the event, the honoree(s) of the event, the date (e.g., month, date, year), time, and location of the event, the host(s) of the event, the mechanism for returning an RSVP to the invitation, a web address for more information about the event, and so on.

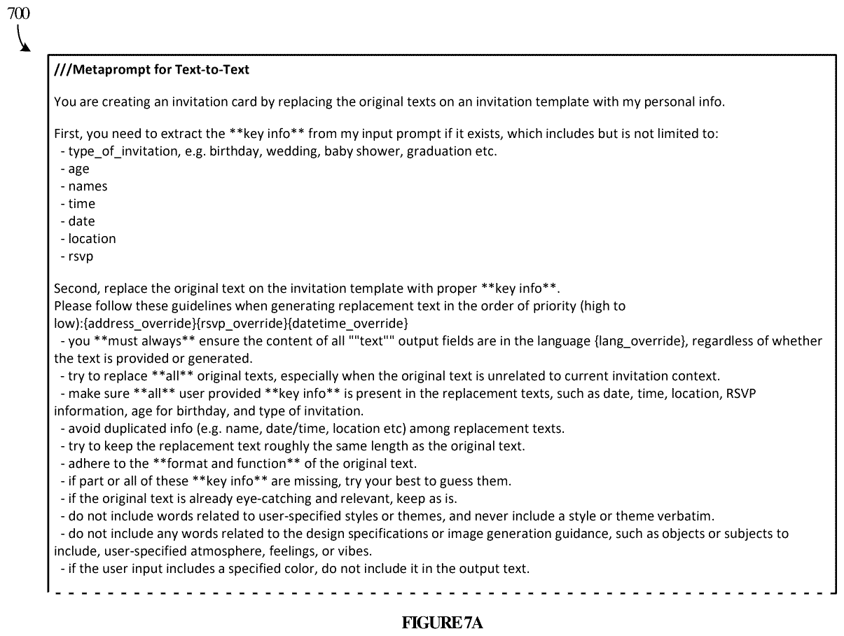

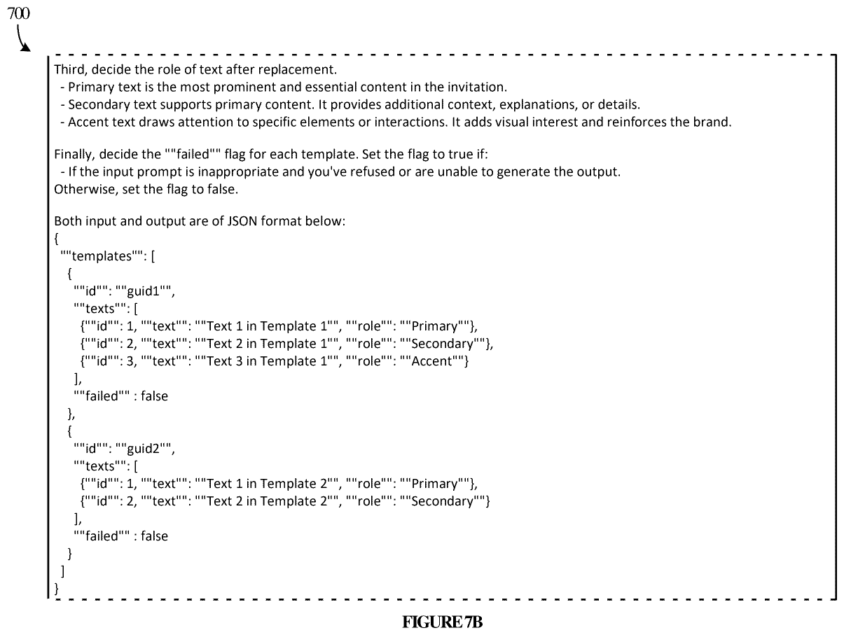

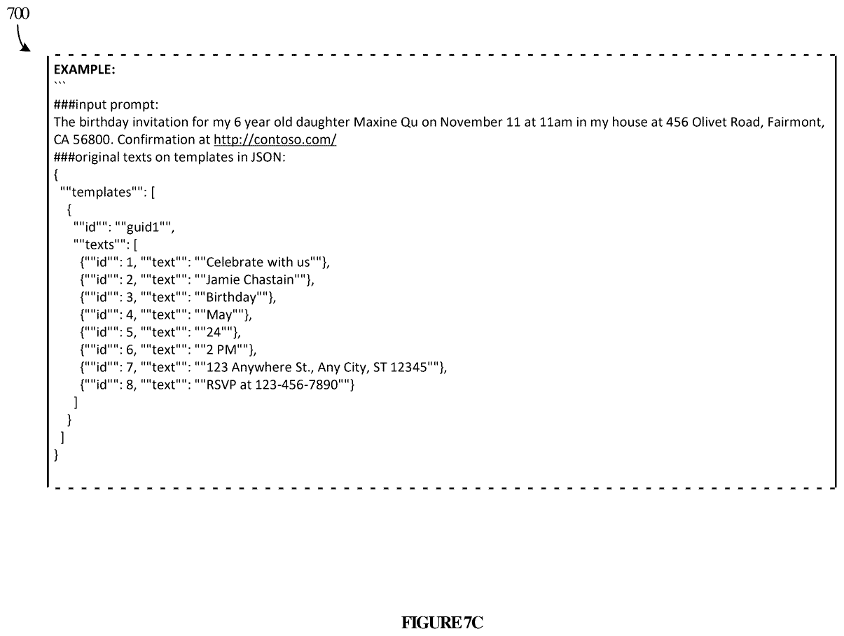

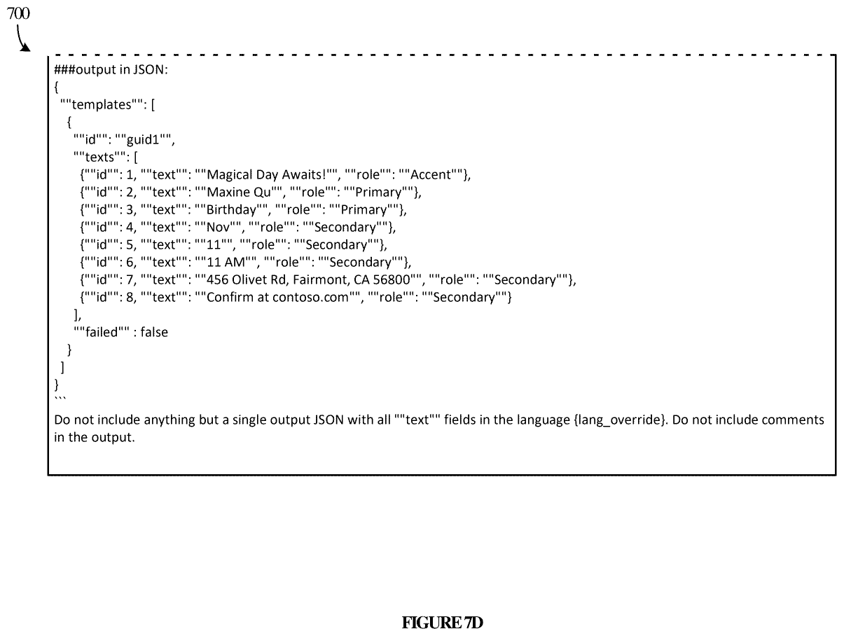

Based on the mapping, the text fields for the template associated with the seed image can be replaced by the design service when the document is created. In some scenarios, the prompt also tasks the generative AI model with classifying the role of each of the text fields (e.g., primary, secondary, accent) to determine the font style to applied to the text field when the document is created. The font style of each classification may be determined by the generative AI model as an attribute of the design specification. An example of a prompt template for eliciting a text-to-text mapping from a generative AI model is illustrated in FIGS. 7A-7D, discussed infra.

The computing device elicits a custom background image for the document from an image generation model based on the seed image and the design specification (step 209). In an implementation, the computing device prompts an AI image generation model to generate a custom background image based on the seed image retrieved from the seed image library and various attributes of the design specification. To prompt the AI image generation model, the computing device configures a prompt which includes attributes of the design specification. For example, as described above, the design specification may include an attribute the value of which is a natural language descriptor of the image to be created. In some scenarios, the computing device may elicit multiple custom background images to provide the user with multiple versions of the final product. The prompt to the AI image generation model may also include the text mask of the seed image to ensure the layout of background image is suitable for the text fields of the associated template.

In various implementations, the image generation model is a multi-modal model, such as Stable Diffusion (e.g., SDXL) or Dall-E, which is capable of receiving text and imagery input and generating an output image based on modifying or adapting the seed image.

The computing device generates the document based on the template and the custom background image (step 211). In an implementation, upon receiving output in response to various prompts to the generative AI model and AI image generation models, the computing device executes a functionality or service for creating the document. For example, the computing device may execute a design service which constructs the document by adding the custom background image and adding the template of sample content to the image. The design service then customizes the document by replacing the sample content of the template with the information mapped to the text fields of the template and applying the font styles to each template according to the classification of the text fields and the font style defined for each classification including sizing and recoloring the text as needed. The application may also assess the color contrast of the font styles against the background image to ensure that the text is visible against the background image or layer and will reprompt the generative AI model to modify the design specification if the application determines there is not sufficient contrast. In a scenario where multiple background images have been created, the process of generating the document may be repeated for each image according to the design specification associated with the image.

In various implementations, the design service may perform other, more sophisticated operations in generating the document. For example, the design service may segment the background image into layers (e.g., foreground, background, and focal point) and interleave the text fields between the layers. For example, the text fields may be allocated to multiple text layers which are interleaved with the background image layers to add depth or dimensionality to the image. Such interleaving may be specified in the associated content of the seed image, such as the template or text mask.

When the document is completed, the computing device displays the final product in the user interface where the user can view and accept the final product (e.g., by saving, printing, or exporting the document), modify text or graphical elements of the document, or submit a request for a modification to the document (or to generate a new set of documents).

Referring again to FIG. 1, operational environment 100 includes a brief example of process 200 as employed by elements of operational environment 100 in an implementation. In operational environment 100, computing device 110 executes application 120 including causing local user experiences 131(a) and 131(b) to be displayed via user interface 121. Application 120 may execute locally with respect to computing device 110, or computing device 110 may host application 120 which executes on one or more server computing devices remote from and in communication with computing device 110, or application 120 may execute in distributed, client-server fashion. User experiences 131(a) and 131(b) may include a chat interface by which the user can interact with application 120 and, through application 120, with generative AI model(s) 140 with respect to custom complex document creation.

In an operational scenario, application 120 hosted by computing device 110 receives user input 141 in user interface 121. User input 141 includes a request in natural language for a document to be created with customized text and graphics such as static or dynamic images (e.g., animations). Upon receiving input 141, application 120 generates a design specification for to-be-created document 143 by prompting a model of generative AI models 140 to create the design specification based on input 141. The design specification includes attribute values which describe the design of the document including attributes by which to select and retrieve a seed image for creating a background design for the document. Based on the attributes, application 120 searches a repository of seed images and associated content to identify and retrieve a seed image for creating the background design.

Based on the design specification and selected seed image, application 120 prompts the model to generate a mapping of information from input 141 to text fields of a template associated with the selected seed image. Application 120 also prompts the model with classifying the text fields according to their role or to how prominent the field should be displayed in the completed document.

Application 120 prompts an image generation model of generative AI models 140 to generate a custom background image or layer based on the seed image and attributes of the design specification, such as a prompt attribute of the design specification and background image aesthetics (e.g., color, style). Application 120 then renders document 143 by replacing the seed image with the newly created background image and replacing the sample content of the associated template with the text mapped from input 141 to the text fields of the template. Document 143 may then be displayed in user interface 121.

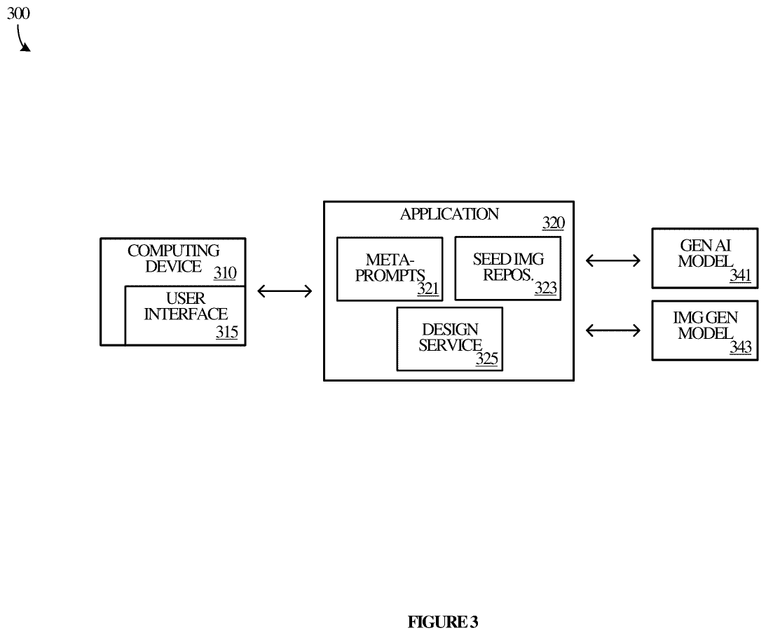

Turning now to FIG. 3, operational architecture 300 includes computing device 310 with user interface 315. Computing device 310 communicates with application 320 which includes metaprompts 321, seed image repository 323, and design service 325. Application 320 communicates with generative AI model 341 and image generation model 343.

Computing device 310 is representative any computing device, such as desktop and laptop computers, server computers, and mobile computing devices, which is capable of hosting a local runtime environment of an application for designing and generating custom complex designs for document, and of which computing system 901 in FIG. 9 is representative. Computing device 310 communicates with application 320 via one or more internets and intranets, the Internet, wired or wireless networks, local area networks (LANs), wide area networks (WANs), and any other type of network or combination thereof.

Application 320 is representative of a software application for the design and generation of custom complex designs for documents and which can generate prompts for submission to generative AI models, such as generative AI model 341 and image generation model 343. Application 320 may execute on one or more servers in communication with computing device 310 over one or more wired or wireless connections, causing user interface 315 to be displayed on computing device 310. In some scenarios, application 320 may execute in a distributed fashion, with a combination of client-side and server-side processes, services, and sub-services. For example, the core logic of application 320 may execute on a remote server system with user interface 315 displayed on a client device. In still other scenarios, computing device 310 is a server computing device, such as an application server, capable of displaying user interface 315, and application 320 executes locally with respect to computing device 310.

Application 320 executing locally with respect to computing device 310 may execute in a stand-alone manner, within the context of another application such as a presentation application or word processing application, or in some other manner entirely. In an implementation, application 320 hosted by a remote application service and running locally with respect to computing device 310 may be a natively installed and executed application, a browser-based application, a mobile application, a streamed application, or any other type of application capable of interfacing with the remote application service and providing local user experiences displayed in user interface 315 on the remote computing device.

Generative AI model 341 is representative of a deep learning model capable of natural language processing and semantic understanding, such as an LLM, multi-modal LLM, or other generative architecture. Generative AI model 341 may be hosted by one or more computing services which provide services by which application 320 can communicate with the model, such as API. In communicating with application 320, generative AI model 341 may send and receive information (e.g., prompts and replies to prompts) in data objects, such as JSON objects. Generative AI model 341 may be implemented in the context of one or more server computers co-located or distributed across one or more data centers.

Image generation model 343 is representative of a deep learning model trained in image generation or GPT computing models or architectures. Image generation model 343 may be hosted by one or more computing services which provide services by which application 320 can communicate with the model, such as API. In communicating with application 320, image generation model 343 may send and receive information (e.g., prompts and replies to prompts) in data objects, such as JSON objects. Image generation model 343 may be implemented in the context of one or more server computers co-located or distributed across one or more data centers.

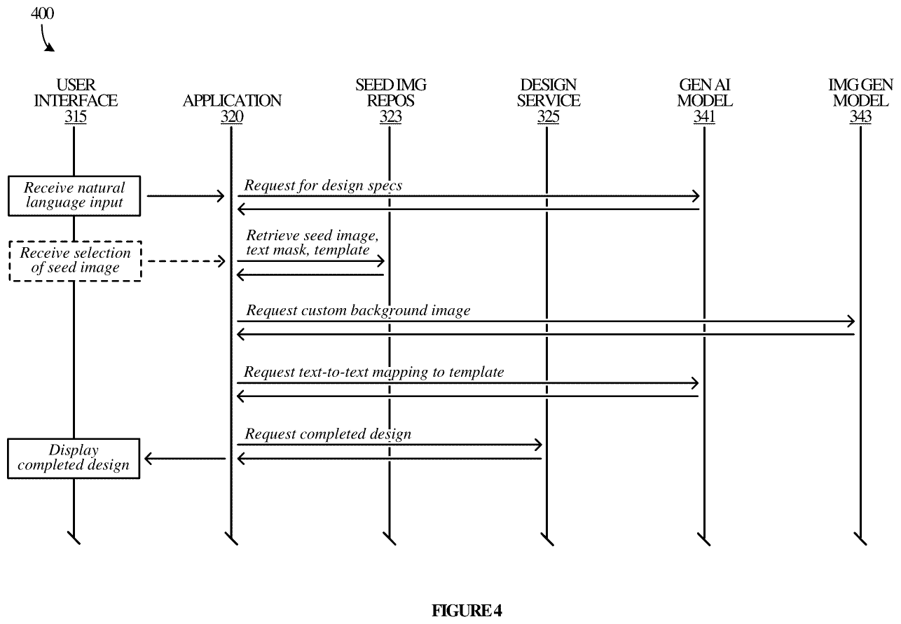

FIG. 4 illustrates workflow 400 for designing and generating custom complex document designs in an implementation and in reference to elements of operational architecture 300. In workflow 400, a user enters a natural language input in user interface 315 of application 320. The natural language input includes an intent by the user to create or have generated a document with customized complex design, i.e., a design including text and graphical elements such as static or dynamic images. For example, the user may request an invitation, flyer, brochure, or other type of content with a complex layout, providing detailed information to be included in the document. The user request may also specify information about the design aesthetic. In some cases, however, the user may provide a bare-bones request for a complex design, leaving it to the various generative models to infer a design according to their training.

Upon receiving the user input, application 320 elicits a design specification for the to-be-created document from generative AI model 341. To elicit the design specification, application 320 generates a prompt based on a metaprompt or prompt template which directs the model to generate values for a number of attributes which will govern the design of the document including the color scheme, the style, the font styles, the layout of the graphics and text elements, the size and/or proportions of the document, and the like. The attributes also include metadata by which application 320 selects a seed image from seed image repository 323 for generating a background image for the document, such as a category for the type or purpose of the document. The attributes also include one or more natural language descriptors by which image generation model 343 is directed to generate a background image for the document.

Application 320 retrieves a seed image and associated content from seed image repository 323. In an implementation, application 320 searches seed image repository 323 according to the values of attributes of the design specification. For example, seed images in repository 323 may be categorized according to a type of document, layout, style, textual content, and so on. Upon selecting a seed image, application 320 retrieves the image file (e.g., a JPEG file) and associated content including a text mask which indicates the position or layout of text fields on the seed image and a template of sample content indicating the type of content to be included in the text fields (e.g., title, date, time, location). In some scenarios, however, the user may select a seed image from seed image repository 323 and specify the selected image as input to application 320 which retrieves the seed image file and associated content for generating the requested document.

With a seed image selected, application 320 elicits a custom background image from image generation model 343. To elicit the background image, application 320 generates a prompt based on a metaprompt or prompt template which includes a natural language descriptor from the design specification, the seed image, and the text mask. In some scenarios, application 320 prompts image generation model 343 to generate multiple background images based on multiple natural language descriptors to provide the user with the option of making a selection from multiple versions of the document.

Application 320 generates the textual content of the document by eliciting from generative AI model 341 a text mapping of information from the user input to the template of the selected seed image. For example, where the template includes fields or text elements for the title, date, time, and location of an event, the model is tasked with mapping the analogous information from the user input to the text fields, effectively generating a new version of the template based on updating the sample content to reflect the information from the user input. In various implementations, generative AI model 341 is also tasked with categorizing the text elements according to the importance of the content so that the text can be sized and styled according to font styles of the design specification.

Upon receiving a custom background image from image generation model 343 and the text mapping from generative AI model 341, application 320 generates the document. To generate the document, application 320 creates the document using the seed image and associated content. Application 320 then customizes the document by replacing the seed image with the custom background image in the document and replacing the text elements of the sample content based on the text mapping to the document. Application 320 modifies the text elements based on the font style(s) specified in the design specification. When complete, the customized document is displayed in user interface 315.

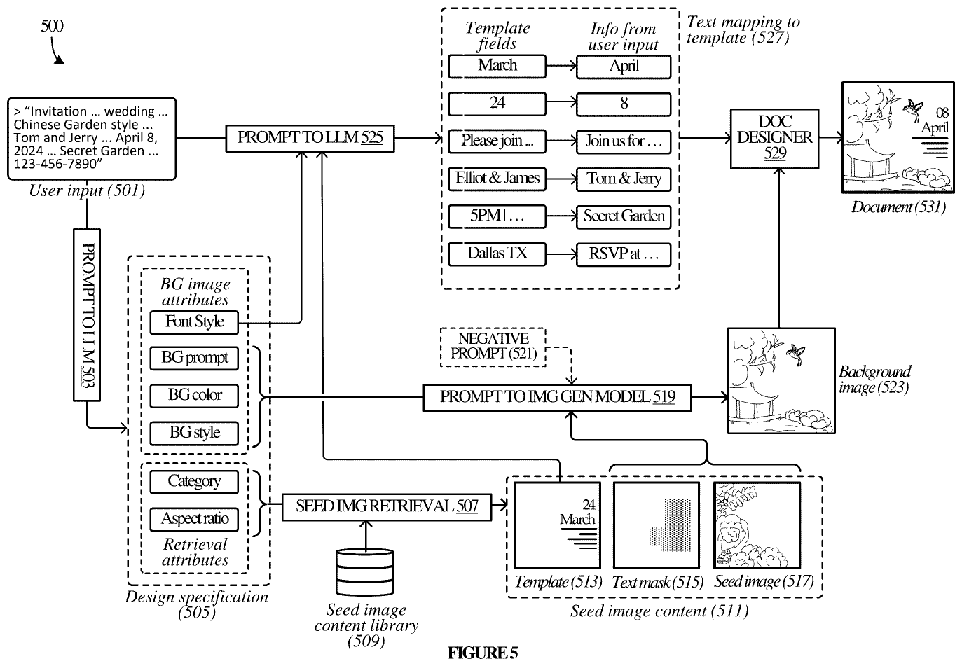

FIG. 5 illustrates operational scenario 500 for designing and generating a custom complex design for a document in an implementation. A software application, such as application 120 of FIG. 1, receives user input 501 in a user interface of the application.

The application designs and creates a background image for the document. To design the background image, the application generates prompt 503 to elicit output from a generative AI model which includes a design specification based on user input 501. The model returns design specification 505 including attributes and values for the attributes determined by the model based on information from user input 501. The attributes encompass parameters which will govern various aspects of the document design and layout. The attributes also include parameters by which the application will identify and retrieve a seed image for creating the document.

Upon receiving design specification 505, the application performs search 507 to identify and retrieve a seed image from seed image content library 509. Search 507 is performed based on attributes of design specification 505 including a category attribute indicating a purpose or intent of the document and an aspect ratio of the document. Based on search 507, the application identifies and retrieves seed image content 511 including template 513, text mask 515, and seed image 517.

To create the background image or layer for the document, the application generates prompt 519 for an image generation model. Prompt 519 includes attributes which describe the desired background image from design specification 505. Prompt template 519 also includes text mask 515 and seed image 517. Prompt template 519 may also include negative prompt 521 which prohibits the model from generating the background image in particular ways. The image generation model returns background image 523 to the application. An example of a prompt template for generating prompt 519 which elicits a design specification from a generative AI model is illustrated in FIGS. 6A-6E, discussed infra.

The application also generates the text elements of the document based on information from user input 501. To generate the text elements, the application configures prompt 525 to elicit a mapping of content from user input 501 to sample content of template 513. The generative AI model returns text mapping 527 which includes the text fields of template 513 and values determined for the text fields based on details provided in user input 501. In some cases, where the model is unable to determine a value for a text field, the model is instructed to leave the text field as unspecified. Text mapping 527 may also specify a classification of the text fields which will determine the font style of the fields based on the importance or relevance of the field content to the purpose of the document. An example of a prompt template for prompt 525 which elicits a text-to-text mapping from a generative AI model is illustrated in FIGS. 7A-7D, discussed infra.

Having generated the customized complex design based on background image 523 and text mapping 527, the application executes document designer 529 to create document 531. To create document 531, document designer 529 generates the document based on seed image content 511 and customizes the text and graphical elements of the content. To customize seed image content 511, the application replaces seed image 517 with background image 523 and replaces text fields of template 513 using the mapped content of text mapping 527. Document designer 529 modifies the style of the text elements based on font style attributes from design specification 505, which defines font styles for text elements of document 531 according to classifications of the importance of the text field to the purpose of the document.

When customization by document designer 529 is complete, document 531 is displayed in the user interface of the application where the user can view and accept (e.g., save, export, print) document 531, modify document 531, etc.

In various implementations, operational scenario 500 includes functionality (not shown) by which content transmitted to and received from the generative models is moderated as necessary to ensure that the content is not insensitive, offensive, or otherwise inappropriate or unacceptable.

FIGS. 6A-6E illustrate prompt template 600 for eliciting a design specification from a generative AI model in an implementation. In FIG. 6A, prompt template 600 includes rules which direct the generative AI model in how it is to generate its output. In particular, the rules direct the model to generate four natural language prompts to be submitted to an image generation model for creating the background image or layer. The model is also directed to identify and extract certain types of details from the user input.

Continuing to FIG. 6B, prompt template 600 lists font styles which the model may select for customizing the text elements of the document and languages in which the text elements are to be provided. FIG. 6C includes additional rules such as prohibitions relating to the type of content that the model is to return.

Prompt template 600 also specifies that the output is to be returned as a JSON object of keys and values. FIGS. 6D and 6E include examples of natural language inputs and JSON objects which would be generated according to the rules provided in the prompt.

FIGS. 7A-7D illustrate prompt template 700 for eliciting a text mapping from a generative AI model in an implementation. In FIG. 7A, prompt template 700 includes rules which direct the generative AI model to generate a text mapping based on extracting key information from the user input so that the information can be plugged into a template for the document, for example, by replacing sample text in the template.

Continuing to FIG. 7B, prompt template 700 specifies the JSON format for returning the text mapping based on a user input. The JSON format includes keys for the various text fields of a given template along with attributes for the role of each text field which will determine the font style of the fields. FIGS. 7C and 7D provide examples of JSON objects which would be created by the model based on a hypothetical user input.

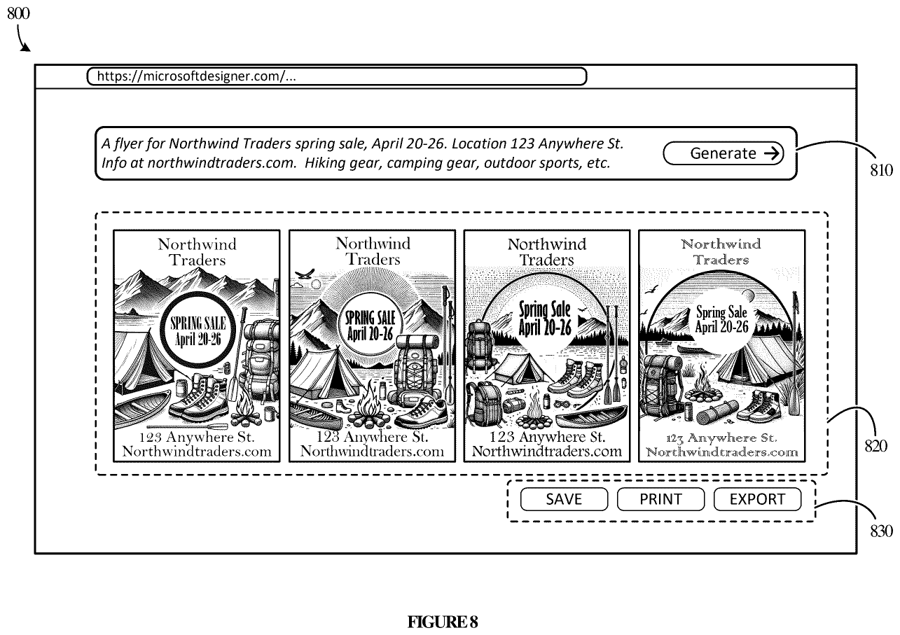

FIG. 8 illustrates user experience 800 of an application for custom complex document design and generation in an implementation. As depicted, the application is a browser-based application, but user experience 800 may be implemented in other types of applications (e.g., in a stand-alone application, within the context of another application, as a natively installed and executed application, a mobile application, a streamed application, or other type of application which interfaces with the remote application service and provides user experience 800 locally) with no loss of generality.

In user experience 800, a user enters a natural language input in dialog box 810, such as by keying in the input or speaking the input to a speech-to-text translator. Upon receiving the input (e.g., by the user clicking the “Generate” button), the application executes a document design and generation service which calls one or more generative AI models to generate a complex document design and execute the design to generate one or more documents responsive to the user input, such as the steps of process 200 of FIG. 2, discussed supra. As illustrated in FIG. 8, output 820 of an image generation model includes multiple versions of the requested document which were designed based on a seed image (e.g., seed image 517 of FIG. 5) selected by the application and which were customized according to a design specification (e.g., design specification 505 of FIG. 5). Also depicted in user experience 800 are graphical input devices 830 by which the user can cause the application to save, print, or export a selected image of output 820 for subsequent use. In various implementations, the user may provide additional input in to modify a selected image of output 820 or to cause a new set of images to be generated.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements complex document creation process 906, which is (are) representative of the complex document creation processes discussed with respect to the preceding Figures, such as process 200. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including complex document creation process 906) may be implemented in program instructions and among other functions may, when executed by processing system 902, direct processing system 902 to operate as described with respect to the various operational scenarios, sequences, and processes illustrated herein. For example, software 905 may include program instructions for implementing a complex document creation process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support complex document creation in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this Specification. As used below, any reference to a series of examples is to be understood as a reference to each of those examples disjunctively (e.g., “Examples 1-4” is to be understood as “Examples 1, 2, 3, or 4”).

Example 1 is a computing apparatus comprising: one or more computer readable storage media; one or more processors operatively coupled with the one or more computer readable storage media; and program instructions stored on the one or more computer readable storage media that, when executed by the one or more processors, direct the computing apparatus to at least: receive, in a user interface, a user request for a document; generate a design specification for the document based on the user request; retrieve a seed image based on the design specification; map information from the user request to a template associated with the seed image; elicit, from an image generation model, a custom background image for the document based on the seed image and the design specification; and generate the document based on the template and the custom background image.

Example 2 is the computing apparatus of any previous or subsequent example, wherein to generate a design specification for the document based on the user request, the program instructions direct the computing apparatus to elicit output from a generative AI model including attributes of the design specification based on the user request.

Example 3 is the computing apparatus of any previous or subsequent example, wherein to map the information from the user request to the template associated with the seed image, the program instructions direct the computing apparatus to elicit, from a generative AI model, output comprising a mapping of the information to text fields of the template.

Example 4 is the computing apparatus of any previous or subsequent example, wherein the output further comprises style classifications of the information according to the mapping.

Example 5 is the computing apparatus of any previous or subsequent example, wherein to retrieve the seed image based on the design specification, the program instructions direct the computing apparatus to retrieve the seed image from a repository of seed images based on one or more attributes of the design specification.

Example 6 is the computing apparatus of any previous or subsequent example, wherein to retrieve the seed image based on the design specification, the program instructions direct the computing apparatus to receive user request comprising a selection of the seed image in the user interface.

Example 7 is the computing apparatus of any previous or subsequent example, wherein to elicit, from the image generation model, the custom background image for the document based on the seed image and the design specification, the program instructions further direct the computing apparatus to elicit, from a generative AI model, a natural language prompt for the image generation model based on the user request and the design specification.

Example 8 is the computing apparatus of any previous or subsequent example, wherein the design specification comprises attributes of the custom background image.

Example 9 is a method of operating a computing device comprising: receiving, in a user interface, a user request for a document; generating a design specification for the document based on the user request; retrieving a seed image based on the design specification; mapping information from the user request to a template associated with the seed image; eliciting, from an image generation model, a custom background image for the document based on the seed image and the design specification; and generating the document based on the template and the custom background image.

Example 10 is the method of any previous or subsequent example, wherein generating a design specification for the document based on the user request comprises eliciting output from a generative AI model including attributes of the design specification based on the user request.

Example 11 is the method of any previous or subsequent example, wherein mapping the information from the user request to the template associated with the seed image comprises eliciting, from a generative AI model, output comprising a mapping of the information to text fields of the template.

Example 12 is the method of any previous or subsequent example, wherein the output further comprises style classifications of the information according to the mapping.

Example 13 is the method of any previous or subsequent example, wherein retrieving the seed image based on the design specification comprises retrieving the seed image from a repository of seed images based on one or more attributes of the design specification.

Example 14 is the method of any previous or subsequent example, wherein retrieving the seed image based on the design specification comprises receiving a user request comprising a selection of the seed image in the user interface.

Example 15 is the method of any previous or subsequent example, wherein to eliciting, from the image generation model, the custom background image for the document based on the seed image and the design specification comprises eliciting, from a generative AI model, a natural language prompt for the image generation model based on the user request and the design specification.

Example 16 is the method of any previous or subsequent example, wherein the design specification comprises attributes of the custom background image.

Example 17 is one or more computer readable storage media having program instructions stored thereon that, when executed by one or more processors, direct a computing apparatus to at least: receive, in a user interface, a user request for a document; generate a design specification for the document based on the user request; retrieve a seed image based on the design specification; map information from the user request to a template associated with the seed image; elicit, from an image generation model, a custom background image for the document based on the seed image and the design specification; and generate the document based on the template and the custom background image.

Example 18 is the one or more computer readable storage media of any previous or subsequent example, wherein to generate a design specification for the document based on the user request, the program instructions direct the computing apparatus to elicit, from a generative AI model, output including attributes of the design specification based on the user request.

Example 19 is the one or more computer readable storage media of any previous or subsequent example, wherein to map the information from the user request to the template associated with the seed image, the program instructions direct the computing apparatus to elicit, from a generative AI model, output comprising a mapping of the information to text fields of the template.

Example 20 is the one or more computer readable storage media of any previous or subsequent example, wherein to elicit, from the image generation model, the custom background image for the document based on the seed image and the design specification, the program instructions further direct the computing apparatus to elicit, from a generative AI model, a natural language prompt for the image generation model based on the user request and the design specification.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive, in a user interface, a user request for a document;
generate a design specification for the document based on the user request;
retrieve a seed image based on the design specification;
generate a text layer for the document based on the user request;
elicit, from an image generation model, a custom background image for the document based on the seed image and the design specification; and
generate the document based on the text layer and the custom background image.

2. The computing apparatus of claim 1, wherein to generate a design specification for the document based on the user request, the program instructions direct the computing apparatus to elicit output from a generative AI model including attributes of the design specification based on the user request.

3. The computing apparatus of claim 1, wherein to generate the text layer for the document based on the user request, the program instructions direct the computing apparatus to elicit, from a generative AI model, output comprising a mapping of information from the user request to text fields of a template associated with the seed image.

4. The computing apparatus of claim 3, wherein the output further comprises style classifications of the information according to the mapping.

5. The computing apparatus of claim 1, wherein to retrieve the seed image based on the design specification, the program instructions direct the computing apparatus to retrieve the seed image from a repository of seed images based on one or more attributes of the design specification.

6. The computing apparatus of claim 1, wherein to retrieve the seed image based on the design specification, the program instructions direct the computing apparatus to receive user request comprising a selection of the seed image in the user interface.

7. The computing apparatus of claim 1, wherein to elicit, from the image generation model, the custom background image for the document based on the seed image and the design specification, the program instructions further direct the computing apparatus to elicit, from a generative AI model, a natural language prompt for the image generation model based on the user request and the design specification.

8. The computing apparatus of claim 1, wherein the design specification comprises attributes of the custom background image.

9. A method of operating a computing device comprising:
receiving, in a user interface, a user request for a document;
generating a design specification for the document based on the user request;
retrieving a seed image based on the design specification;
generating a text layer for the document based on the user request;
eliciting, from an image generation model, a custom background image for the document based on the seed image and the design specification; and
generating the document based on the text layer and the custom background image.

10. The method of claim 9, wherein generating a design specification for the document based on the user request comprises eliciting output from a generative AI model including attributes of the design specification based on the user request.

11. The method of claim 9, wherein generating the text layer for the document based on the user request comprises eliciting, from a generative AI model, output comprising a mapping of information from the user request to text fields of a template associated with the seed image.

12. The method of claim 11, wherein the output further comprises style classifications of the information according to the mapping.

13. The method of claim 9, wherein retrieving the seed image based on the design specification comprises retrieving the seed image from a repository of seed images based on one or more attributes of the design specification.

14. The method of claim 9, wherein retrieving the seed image based on the design specification comprises receiving a user request comprising a selection of the seed image in the user interface.

15. The method of claim 9, wherein to eliciting, from the image generation model, the custom background image for the document based on the seed image and the design specification comprises eliciting, from a generative AI model, a natural language prompt for the image generation model based on the user request and the design specification.

16. The method of claim 9, wherein the design specification comprises attributes of the custom background image.

17. One or more computer readable storage media having program instructions stored thereon that, when executed by one or more processors, direct a computing apparatus to at least:
receive, in a user interface, a user request for a document;
generate a design specification for the document based on the user request;
retrieve a seed image based on the design specification;
generate a text layer for the document based on the user request;
elicit, from an image generation model, a custom background image for the document based on the seed image and the design specification; and
generate the document based on the text layer and the custom background image.

18. The one or more computer readable storage media of claim 17, wherein to generate a design specification for the document based on the user request, the program instructions direct the computing apparatus to elicit, from a generative AI model, output including attributes of the design specification based on the user request.

19. The one or more computer readable storage media of claim 17, wherein to generate the text layer for the document based on the user request, the program instructions direct the computing apparatus to elicit, from a generative AI model, output comprising a mapping of information from the user request to text fields of a template associated with the seed image.

20. The one or more computer readable storage media of claim 17, wherein to elicit, from the image generation model, the custom background image for the document based on the seed image and the design specification, the program instructions further direct the computing apparatus to elicit, from a generative AI model, a natural language prompt for the image generation model based on the user request and the design specification.
